(19) United States
(12) Patent Application Publication
(10) Pub. No.: US 2020/0399908 A1
(43) Pub. Date: Dec. 24, 2020

(54) ADJUSTABLE MAGNETIC COUPLER

(71) Applicant: Philip Rodney LEWIS, Orelia (AU)

(72) Inventor: Philip Rodney LEWIS, Orelia (AU)

(21) Appl. No.: 16/643,582

(22) PCT Filed: Aug. 28, 2018
(86) PCT No.: PCT/AU2018/050921

§ 371 Date: Mar. 1, 2020

(30) Foreign Application Priority Data
Aug. 29, 2017 (AU) 2017903483

(51) Int. Cl. E04F 13/08; F16B 5/02; F16B 39/12; E04B 9/24; E04F 15/02; B65D 90/04

(52) U.S. Cl. CPC E04F 13/0883; F16B 5/0233; F16B 39/12; E04H 2001/1283; E04F 15/02144; E04F 13/0853; B65D 90/043; E04B 9/248

(57) ABSTRACT

Provided is an adjustable magnetic coupler 10 for operatively and removably attaching cladding 20 to a ferromagnetic surface 12.5, the coupler 10 including a first body 12 including a first magnetised element 12.3 for attaching to the ferromagnetic surface 12.5, the first body 12 operatively associated with a second body 14 which includes a second magnetised element 14.4 configured for magnetically attaching to an article of cladding 20 to be attached to the ferromagnetic surface 12.5 via the coupler 10. Also included is an adjustor 16 for selectively adjusting the distance between the first and second elements to adjust a separation between said cladding and the ferromagnetic surface.

### TECHNICAL FIELD

This invention relates to connectors for cladding surfaces, generally in the field of construction. More specifically, this invention relates to an adjustable magnetic coupler for operatively and removably attaching cladding to a ferromagnetic surface, a cladding system for cladding a ferromagnetic surface, and an associated method for cladding a ferromagnetic surface.

### BACKGROUND ART

The following discussion of the background art is intended to facilitate an understanding of the present invention only. The discussion is not an acknowledgement or admission that any of the material referred to is or was part of the common general knowledge as at the priority date of the application.

Intermodal containers are well known in the art. These containers generally include standardized shipping containers, cargo or freight containers, ISO containers, so-called shipping, sea or ocean containers, a container van or box, a Conex box, or the like. Increasingly, use is being made of such intermodal containers, typically metal shipping containers, for residential or commercial building purposes, due to ease-of-use, availability and standardised sizes.

These containers may be outfitted with internal walling to render the insides of the container flat and suitable for habitation. This is typically done using a complex system of battens that are affixed to the internal surface of the containers, using screws that penetrate the external metal walls of the container from the outside. Wall panels or cladding panels are then affixed internally to the battens using glues, nails or screws, which then need to be rendered to achieve a smooth finish, covering over the nails or screws. In addition, fixing the battens by passing nails or screws through the external wall of the container means that great care has to be taken to ensure that moisture, typically from precipitation, does not pass through the apertures and into the interior of the intermodal container.

A further issue is that the interior walls of many previously used containers are not plumb and many contain pronounced curves, dents, or inward protrusions which have to be carefully allowed for by using the services of expert carpenters or fitters that can increase or decrease the thickness of individual battens in attempt to keep the interior cladding as true and straight as possible.

The present invention was conceived with these issues in mind.

### SUMMARY OF THE INVENTION

The skilled addressee will appreciate that reference herein to ‘cladding’ generally refers to an article of covering or facing as an outer layer of a surface, generally for finishing, ornament, and/or protection thereof, as is generally used in the art of construction. Such cladding may be useable for any appropriate construction surface, such as a wall covering, a ceiling covering, flooring, roofing, etc. Examples of such cladding may include a tile, a slab, or any suitable tegular article as will be apparent to the skilled addressee.

According to a first aspect of the invention there is provided an adjustable magnetic coupler for operatively and removably attaching cladding to a ferromagnetic surface, the coupler including:

a first body including a first magnetised element for attaching to the ferromagnetic surface, the first body operatively associated with a second body which includes a second magnetised element configured for magnetically attaching to an article of cladding to be attached to the ferromagnetic surface via the coupler; and an adjustor for selectively adjusting the distance between the first and second elements to adjust a separation between said cladding and the ferromagnetic surface.

Typically, the adjustor is a threaded shaft configured to threadedly engage a complementarily threaded aperture in the first and/or second body allowing for adjustment in infinite increments of a distance between the first and second magnetised elements.

In one example, the second element is configured for attaching to the article of cladding via suitable attachment means.

In another embodiment, the adjustor is in the form of an incremental adjustor that allows for adjustment in stepped increments of a distance between the first and second magnetised elements such as by way of a snap-fit, click-fit, pin & hole arrangement, or ratchet mechanism.

The adjustor is typically in the form of a connector that serves to interspace the first and second bodies, and hence the first and second magnetised elements.

Typically, the adjustor is unitary with either the first or second bodies.

Alternatively, the adjustor is separate from the first and second bodies.

Typically, each adjustor is configured for selectively adjusting the distance between the first and second bodies by including a locking mechanism to lock the threaded shaft in place relative to at least one of the first or second body.

Typically, the locking mechanism includes a lock nut for locking the threaded shaft in place relative to a body, the lock nut including radially spaced tines that operatively interact with a body, thereby locking the shaft in place once a desired separation has been achieved.

According to a second aspect of the invention, there is provided a cladding system for cladding a ferromagnetic surface, the cladding system including:

a plurality of adjustable magnetic couplers in accordance with the first aspect of the invention; and

a plurality of ferromagnetic articles of cladding for removable operative attachment to the ferromagnetic surface, a separation between said articles of cladding and the ferromagnetic surface adjustable by means of the adjustors of each magnetic coupler.

According to a third aspect of the invention, there is provided a cladding system for cladding a ferromagnetic surface, the cladding system including:

a plurality of adjustable magnetic couplers each having a first body including a first magnetised element for attaching to the ferromagnetic surface; and

at least one article of cladding defining a plurality of second bodies each operatively associated with a first body; and

a plurality of adjustors each for operatively associating a first body with a second body, each adjustor configured for selectively adjusting the distance between the first and second bodies to adjust a separation between said article of cladding and the ferromagnetic surface.

Typically, each adjustor is a threaded shaft configured to threadedly engage a complementarily threaded aperture in a first and/or second body allowing for adjustment in infinite increments of a distance between the first and second bodies.

Typically, each adjustor is configured for selectively adjusting the distance between the first and second bodies by including a locking mechanism to lock the threaded shaft in place relative to at least one of the first or second body.

Typically, the locking mechanism includes a lock nut for locking the threaded shaft in place relative to a body, the lock nut including radially spaced tines that operatively interact with a body, thereby locking the shaft in place once a desired separation has been achieved.

Typically, the article of cladding is substantially planar, typically in the form of a cladding panel or tile.

Typically, the article of cladding is in the form of conventional drywall, synthetic, natural, metal, stone, or wood panelling.

Typically, the article of cladding is provided with a plurality of second bodies.

In one embodiment, the article of cladding is provided with an array of second bodies in a particular arrangement.

Typically, the second bodies of each article of cladding is countersunk into a surface of the article of cladding that is, when mounted, proximal the adjustor.

Typically, the plurality of second bodies are provided internal to the article of cladding.

Typically, the ferromagnetic surface is an interior or exterior wall of an intermodal container.

Typically, the ferromagnetic surface is an interior or exterior ceiling section, or floor section, of an intermodal container.

In other embodiments, the ferromagnetic surface is part of walling, roofing, flooring or fencing systems possessing ferromagnetic surfaces.

As such, the cladding system may be used to provide a planar, substantially flat surface to surfaces that are usually corrugated, ribbed, pressed, boxed, rib-and-pan, or crenelated.

Advantageously, each coupler may be deployed in a recessed area of the ferromagnetic surface and adjusted in length to correspond to a generally plumb or straight line between successive couplers, i.e. have the second magnetised elements substantially in register in a single plane.

The invention extends thus, in another aspect thereof, to a cladding element having associated therewith one or more magnetic elements capable of interacting with the adjustable magnetic coupler of the invention.

The invention extends thus, in another aspect thereof, to a cladding element having associated therewith one or more magnetic elements capable of interacting with the adjustable magnetic coupler of the invention, as described herein.

As used herein, the term “magnetised element” refers to one or more magnets attached directly to the first or second bodies, or to one or more magnets attached via an interposed base plate to the first or second bodies. The term “magnet” may refer to any material or object that produces a magnetic field. Depending on the type of ferromagnetic surface and the weight and size of the cladding material, this may typically be a magnet having no less than an N32 rating.

By “magnetic element” is meant an element that may be ferromagnetic or may be a magnet. The magnetic elements which form part of the cladding element may each thus be either a ferromagnetic element or a magnetised element (i.e. a magnet). By “ferromagnetic” is meant any material that is capable of being attracted by a magnet or magnetic element. Typically, the magnets may be high strength magnets. The magnets may be magnets made from rare earth elements such as samarium-cobalt or neodymium-iron-boron (NIB).

Typically, the magnets include so-called ‘pot magnets’, generally being manufactured from rare earth materials that are set, polarised and charged within a pot, thereby allowing for flux control on peripheral surfaces of a magnet to provide significant strength whilst allowing removability, as per requirements in cladding practices.

The invention also extends in a further aspect thereof to a kit for cladding a ferromagnetic surface, the kit including one or more adjustable magnetic couplers of the invention and one or more articles of cladding or cladding elements of the invention, as described herein.

According to a further aspect of the invention, there is provided a method for cladding a ferromagnetic surface, said method including the steps of:

providing a plurality of adjustable magnetic couplers in accordance with the first or second aspects of the invention;

providing a plurality of ferromagnetic articles of cladding in accordance with the first or second aspects of the invention; and

attaching and adjusting a separation between said articles of cladding and the ferromagnetic surface by means of the adjustor of each magnetic coupler.

According to a still further aspect of the invention, there is provided a method of cladding a ferromagnetic surface, said method including the steps of:

providing one or more cladding elements of the invention for cladding a desired ferromagnetic surface, the cladding elements each including a desired number of attaching elements associated therewith;

providing one or more adjustable magnetic couplers of the invention, typically corresponding to the number of attaching elements on the one or more cladding elements;

attaching the one or more adjustable magnetic couplers to the ferromagnetic surface;

adjusting the length of the magnetic couplers using the adjustment formation to a desired distance from the ferromagnetic surface which the one or more cladding elements are to be attached to; and

attaching the one or more cladding elements to the adjustable magnetic couplers, thereby cladding the surface of the ferromagnetic surface.

### BRIEF DESCRIPTION OF THE DRAWINGS

The description will be made with reference to the accompanying drawings in which:

FIG. 1 shows a three-dimensional view of an adjustable magnetic coupler in accordance with one aspect of the invention;

FIG. 1A shows a three-dimensional view of the coupler of FIG. 1, having a lock nut included;

FIG. 1B shows a cross-sectional side view of the coupler of FIG. 1A;

FIG. 2 shows a top plan view of a cladding system in accordance with one aspect of the invention, when mounted to an inner wall of an intermodal container;

FIG. 3 shows a three-dimensional view of a cladding system in accordance with one aspect of the invention, when mounted to a wall of an intermodal container; and

FIG. 4 shows a cross-sectional view of a cladding panel attached to a ceiling of an intermodal container.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above. In the figures, incorporated to illustrate features of the example embodiment or embodiments, like reference numerals are used to identify like parts throughout.

With reference to the Figures, reference numeral 10 is used throughout this specification to indicate an adjustable magnetic coupler of the invention. In general, the magnetic coupler 10 is for operatively and removably attaching cladding 20 to a ferromagnetic surface 12.5, the coupler 10 including a first body 12 including a first magnetised element 12.3 for attaching to the ferromagnetic surface 12.5, the first body 12 operatively associated with a second body 14 which includes a second magnetised element 14.4 configured for magnetically attaching to an article of cladding 20 to be attached to the ferromagnetic surface 12.5 via the coupler 10. Also included is an adjustor 16 (different embodiments hereof described below) for selectively adjusting the distance between the first and second elements to adjust a separation between said cladding and the ferromagnetic surface.

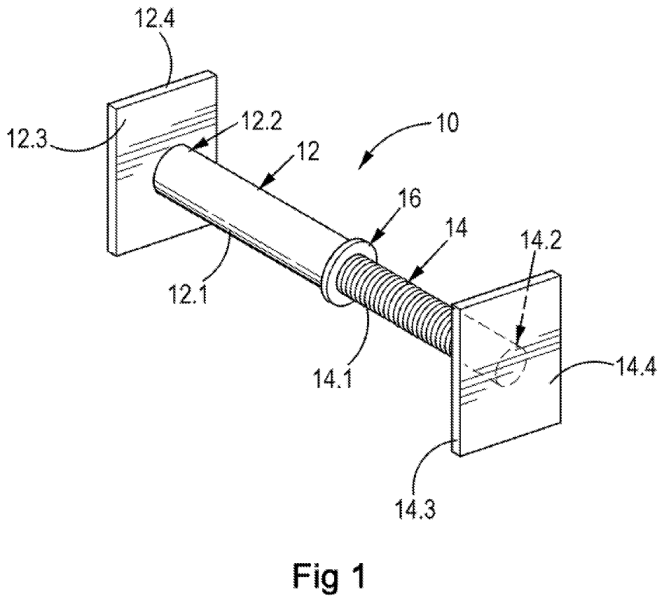

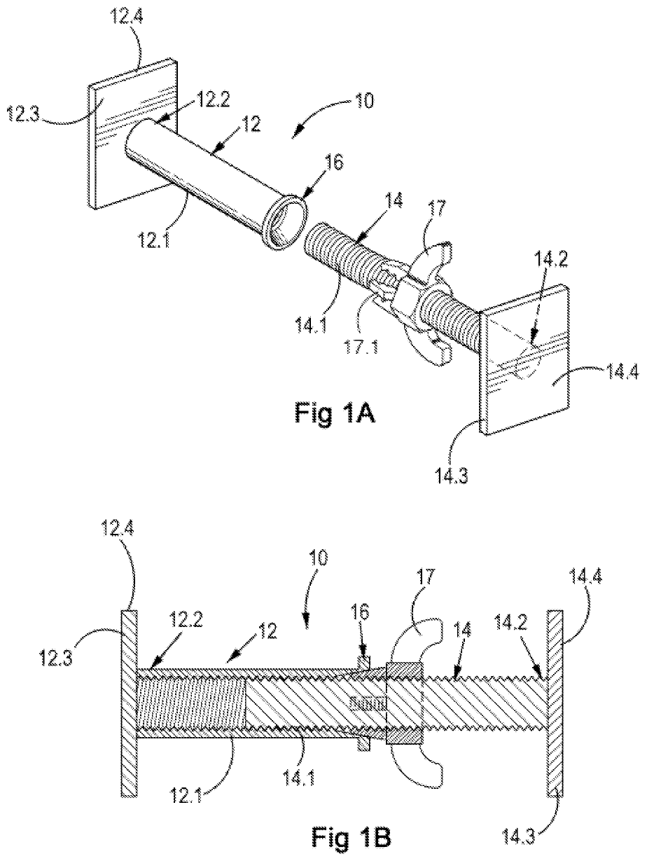

In one embodiment, the adjustor 16 includes a threaded shaft allowing infinite incremental adjustment between the first and second bodies (shown in FIG. 1). In a further embodiment (shown in FIGS. 1A and 1B), the adjustor 16 may include an additional lock nut to allow controlled adjustment, or the like, as described below.

The invention also relates, generally, to a method of cladding the interior and/or exterior of shipping containers or any other suitable ferromagnetic surface with cladding elements or articles of cladding without external screws or fasteners being evident or required to be used on the external (i.e. visible) side of the cladding panels. Many containers have irregular, bent, or dented interior walls, and the adjustability of the coupler of the invention allows for the varying distance from a flat plane between each section of a ferromagnetic wall to be tailored such that the resultant cladding is flush and straight, in a single plane. Of course, the invention is not limited to intermodal containers and can be used to clad any suitable ferromagnetic surface.

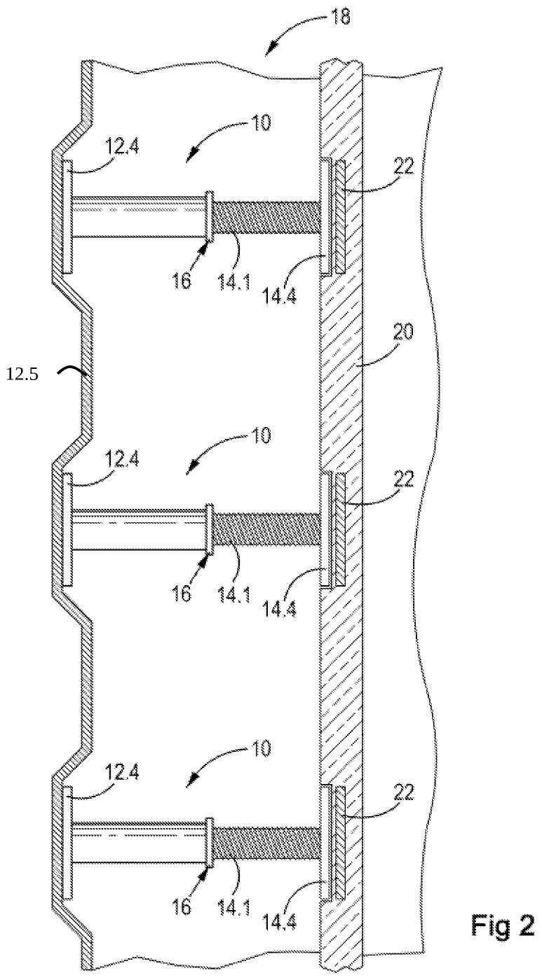

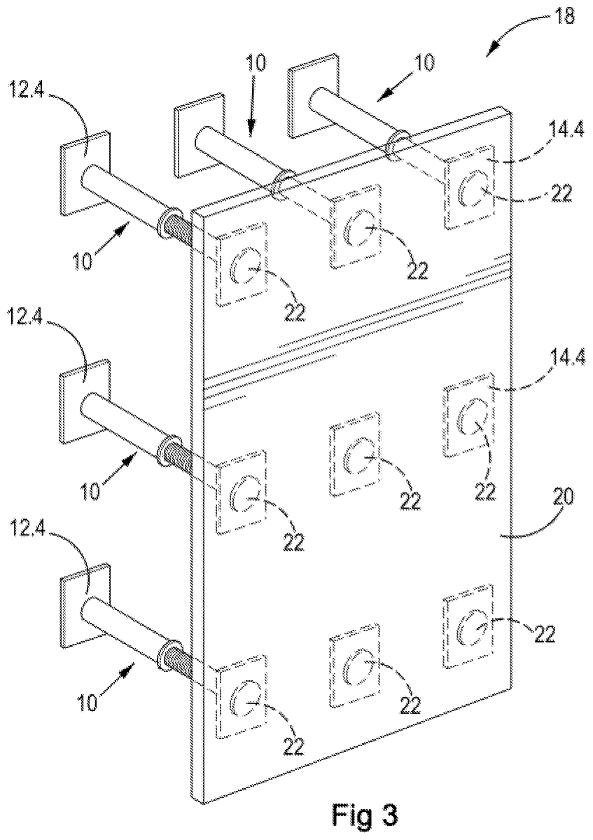

Referring to FIG. 1, one embodiment of an adjustable magnetic coupler 10 for attaching to at least one ferromagnetic surface 12.5 is shown. The coupler 10 comprises an elongate first body 12 in the form of a shaft 12.1 that includes, at a first end 12.2 thereof, a platform 12.3 that, in the embodiment shown, includes a high strength magnet 12.4 integrally formed therewith for attaching to a ferromagnetic surface 12.5 such as an inner surface (i.e. wall, ceiling, or floor, shown as reference numeral 24 in FIGS. 2 to 4) of an intermodal container or any other suitable ferromagnetic surface. The magnets are exemplified as a square or rectangular shape, but any shapes are possible and within the scope of the invention, such as round magnets, etc.

The platform 12.3 may, of course, comprise a metal or inert material to which the magnet 12.4 is mounted, and the platform is roughly the shape of the magnet 12.4. In one example, the platform 12.3 comprises a shell, housing or pot for the magnet, such as for a pot magnet, generally being manufactured from rare earth materials that are set, polarised and charged within a pot, or the like.

Typically, the magnet 12.4 is a rare earth magnet such as a neodymium-iron-boron (NIB) magnet or, in other embodiments, a samarium-cobalt magnet. There are many suitable magnets that can be employed for use in the system of the invention by a person of skill in the field of the invention, given that a plurality of couplers and magnets will usually be employed to attach a cladding panel to a ferromagnetic wall (see description below). The strength, number, and spacing of the magnets and magnetised elements may be selected to provide a secure attachment of the cladding panel to the ferromagnetic surface.

In one embodiment, the shaft 12.1 is typically hollow and internally threaded. The coupler 10 further comprises a second body 14, which is in the form of an elongate shaft 14.1 that has a thread complementary to that of shaft 12.1, and is shaped and dimensioned for entering, and being received by, shaft 12.1.

The shaft 14.1 of the second body 14 has, at a first end 14.2 thereof, a platform 14.3 in the form of a high strength magnet 14.4. Similarly, as with the first body 12, the magnet 14.4 of the second body 14 is mounted directly to the shaft 14.1, or via an intermediate platform corresponding roughly in shape to the magnet 14.4. It is to be appreciated by the skilled addressee that other attachment means may be used in place of magnet 14.4, such as mechanical attachment means, e.g. press-fit couplings, hook-and-loop couplings, friction fit couplings, adhesives, etc., and/or the like, and that such variations are within the scope of the present invention.

The threaded shafts 12.1, 14.1 cooperate to form an adjustor 16 for adjusting the distance between the first and second magnetised elements or magnets 12.4, 14.4. In this way, the overall length of the coupler 10 can be adjusted to account for variances in the ferromagnetic surface to which one or more cladding panels are to be attached. The adjustor 16 further may include a locking mechanism in the form of a lock nut 17 (in this embodiment, a wing-nut) for locking the threaded shafts 12.1 and 14.1 in place relative to one another, as may best be seen in FIGS. 1A and 1B, the lock nut including radially spaced tines 17.1 that interact with shaft 12.1 and 14.1, thereby locking in the length of adjustor 16, once a desired length has been achieved. However, it is to be appreciated that other configurations for a suitable locking mechanism is possible, as will be understood by the skilled addressee, and within the scope of the present invention.

As such, adjustor 16, defined by threaded shafts 12.1 and 14.1 in this embodiment, allows for adjustment in infinite increments of the distance between the first and second magnets 12.4, 14.4. In another embodiment (not shown), the adjustor is in the form of a click-fit or interference sit system that allows for adjustment in stepped increments of the distance between the first and second magnets 12.4, 14.4.

As may best be seen in FIGS. 2 to 4, in use, the adjustable magnetic coupler forms part of a system, indicated generally by reference number 18, that provides a cladding system for cladding ferromagnetic surfaces. The system includes adjustable magnetic couplers 10 of the invention and cladding elements in the form of cladding panels 20 that, together, serve to smoothly clad uneven or irregular ferromagnetic surfaces.

Each cladding panel 20 is generally planar and made of typical materials used for cladding such as fibreboard, drywall sections, wood, synthetic materials, natural materials, or even metal panels, or combinations thereof.

Each cladding panel 20 is provided with, in this embodiment, six circular rare earth magnets 22 each having a charge opposite to the magnets 14.4 forming part of the adjustable couplers 10. Of course, different embodiments may have different numbers and configurations of couplers 10, as will be appreciated by the skilled addressee. In addition, in accordance with an aspect of the invention, an embodiment of the invention may not have magnets 22 in the panel 20. For example, magnets 14.4 and 22 may not be required, with the elongate shaft 14.1 incorporated into, or fast with, panel 20, without detracting from the scope of the present invention.

It is to be appreciated that an article of cladding or panel 20 may define a plurality of second bodies as described herein. Such second bodies may be arranged in an array or a particular arrangement, depending on requirements. For example, cladding panel 20 may have evenly spaced second bodies, or may have an array of second bodies at an upper portion thereof to counteract a weight of the panel 20, or the second bodies may be arranged in strips along a length thereof, or the like.

In one embodiment, the magnets 22 are charged, shaped and dimensioned to interact magnetically with the magnet 14.4 of the adjustable magnetic coupler 10 to allow at least one cladding panel 20 to be attached magnetically to the magnetised surface via the adjustable magnetic coupler 10. Of course, if the cladding panel 20 is itself made of a ferromagnetic surface, then it need not be provided with magnets to allow it to attach to the adjustable magnetic coupler 10. In certain embodiments, the elements enumerated using reference numeral 22 may be ferromagnetic disks or plates (i.e. metal plates) and need not of necessity be magnets. As mentioned, shafts 14.1 may be integral or form part of panel 20, be operatively receivable in threaded second bodies defined on the panel 20, and/or the like.

The magnets 22 may or may not be countersunk, as in the embodiment shown, but may also be stuck to an outer surface 20.1 of the cladding panel 20 or be internal to (i.e. hidden) within the cladding panel 20, but still able to be attracted to the magnetic adjustable coupler 10.

The magnets 22 of the cladding panel 20 are of similar size to each other and have cross-sectional diameters that correspond generally to the cross-sectional diameter of the magnets 14.4 provided on each adjustable magnetic coupler 10 used to fasten the cladding panel 20 to an interior wall of an intermodal container or similar ferromagnetic surface.

In use, the adjustable connector 10 is attached via magnet 12.4 to a ferromagnetic wall or surface 24 to be cladded. A number of the magnetic couplers 10 are positioned on the wall 24 corresponding generally to where the magnets 22 of the cladding panel 20 will be once the panel 20 is mounted. The length of each coupler 10 is adjusted by screwing the bodies 12 and 14 in or out, such that the magnets 14.4 of the second body 14 are all aligned (i.e. plumb and straight). The cladding panel 20 is then attached to the couplers 10 via magnets 22. Due to the adjustability of the coupler 10, the panels 20 should be straight, plumb and true, irrespective of whether the underlying ferromagnetic wall 24 is bent, dented, or irregular.

In one embodiment, the magnets (or ferromagnetic disks) 22 of the cladding panel 20 each have a polarity opposite that of the magnet 14.4 on the second body 14 of the coupler, thereby to attach the panel 20 securely to the wall 24 via coupler 10.

Depending on the type and polarity of magnets (or ferromagnetic disks) 22 used in the cladding panel 20, the magnetic attraction serves to not only attract it to magnet 14.4, but also to the ferromagnetic wall 24 itself, or to the magnet 12.4 provided on the first body, thereby facilitating the attractive force and further securing the panel 20 to the wall 24.

It follows that the cladding system 18 of the invention finds use not only in cladding interior walls of an intermodal container. The system 18 can be used to clad any ferromagnetic surface, including exterior walls of such containers and also corrugated fences such as Colorbond® fences, sheds, garages, steel frame constructions (domestic and commercial), and the like. The invention is not intended to be limited to any particular structure, given the wide applicability thereof.

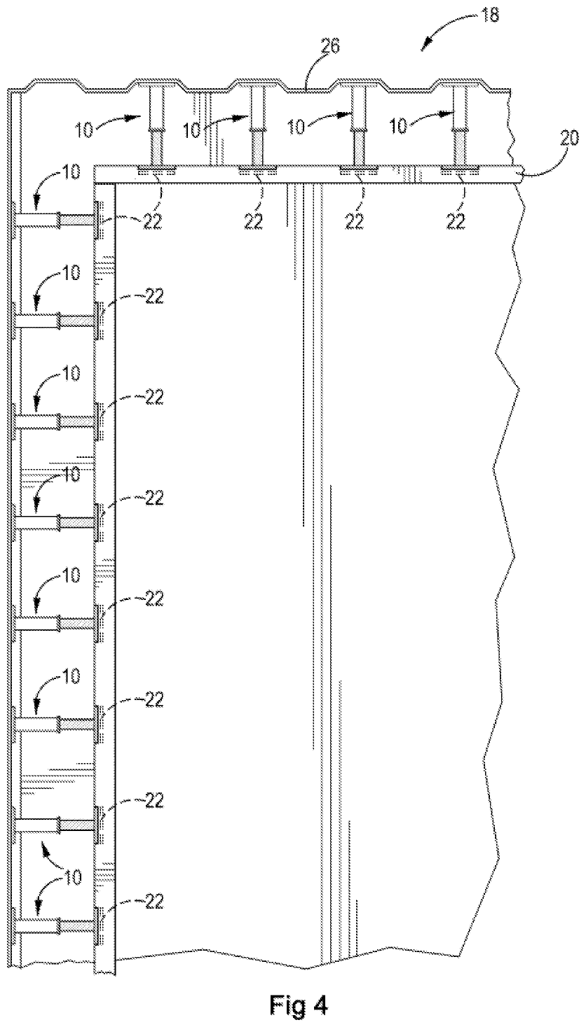

FIG. 4 shows how the cladding system 18 of the invention is used to clad a ceiling 26 of an intermodal container. As with the process of cladding the interior walls 24, the cladding of the ceiling can similarly occur using the system 18 of the invention.

As such, the cladding system may be used to provide a planar, substantially flat surface to surfaces that are usually corrugated, ribbed, pressed, boxed, rib-and-pan, or crenelated. Advantageously, each coupler is deployed in a recessed area of the ferromagnetic surface and adjusted in length to correspond to a generally plumb or straight line between successive couplers, and in certain instances the coupler 10 is recessed deep enough that the cladding panel 20 touches or very nearly touches protruding parts of the walls, thereby maximising interior space in such containers.

The invention extends thus, in another aspect thereof, to a cladding element 20 having associated therewith one or more magnets 10 or second bodies 14 capable of interacting with the adjustable magnetic coupler of the invention.

The invention also extends in a further aspect thereof to a kit for cladding a ferromagnetic surface 26, the kit including one or more adjustable magnetic couplers 10 of the invention and one or more cladding panels 20 of the invention, as described herein.

Applicant regards it as particularly advantageous that the present invention provides for the adjustable magnetic coupler able to act not only as a connector for connecting the articles of cladding or cladding elements to the ferromagnetic surface, but also as a spacer which can be adjusted using the adjustor or adjustment formation to compensate for irregularities in the ferromagnetic surface to ensure that the one or more cladding elements or articles of cladding form a smooth, regular, and straight surface when the coupler lengths are adjusted to compensate for such irregularities and to minimize angular misalignment between successive cladding elements used to clad a ferromagnetic surface.

In addition, a further advantage provided by the present invention is that the adjustable magnetic couplers can attach articles of cladding in a manner which is largely impervious to movement in the ferromagnetic surface. Conventional cladding practices may suffer when a clad surface moves, e.g. building shift or settling, foundation movement, seismic movement, etc. Where there is such movement of a surface, conventional fastening elements like adhesives, screws, nails, rivets, bolts, etc. are typically negatively affected, which is a distinct advantage of the magnetic cladding provided by the present invention. Similarly, the cladding is attached in a removable manner and is able to accommodate subsequent changes in the ferromagnetic surface. For example, if an intermodal container or similar ferromagnetic surface is dented, the invention allows suitable adjustment to the cladding attachment so that a finished surface remains flat and even.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Such spatially relative terms are not meant to limit the scope of the invention in any manner, unless expressly indicated.

Reference to “one example” or “an example” of the invention, or similar exemplary language (e.g., “such as”) herein, is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise.

Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. An adjustable magnetic coupler for operatively and removably attaching cladding to a ferromagnetic surface, being an interior or exterior wall and/or ceiling section, or floor section, of an intermodal container, the coupler including:
a first body including a first magnetised element for attaching to the ferromagnetic surface, the first body operatively associated with a second body which includes a second magnetised element configured for magnetically attaching to an article of cladding to be attached to the ferromagnetic surface via the coupler; and
an adjustor for selectively adjusting the distance between the first and second elements to adjust a separation between said cladding and the ferromagnetic surface.

2. The magnetic coupler of claim 1, wherein the adjustor is a threaded shaft configured to threadedly engage a complementarily threaded aperture in the first and/or second body allowing for adjustment in infinite increments of a distance between the first and second magnetised elements.

3. The magnetic coupler of claim 1, wherein the second element is configured for attaching to the article of cladding via suitable attachment means.

4. The magnetic coupler of claim 1, wherein the adjustor is in the form of an incremental adjustor that allows for adjustment in stepped increments of a distance between the first and second magnetised elements such as by way of a snap-fit, click-fit, pin & hole arrangement, or ratchet mechanism.

5. The magnetic coupler of claim 1, wherein the adjustor is in the form of a connector that serves to interspace the first and second bodies, and hence the first and second magnetised elements.

6. The magnetic coupler of claim 1, wherein the adjustor is unitary with either the first or second bodies.

7. The magnetic coupler of claim 1, wherein the adjustor is separate and distinct from the first and second bodies.

8. The magnetic coupler of either claim 7, wherein each adjustor is configured for selectively adjusting the distance between the first and second bodies by including a locking mechanism to lock the threaded shaft in place relative to at least one of the first or second body.

9. The magnetic coupler of claim 8, wherein the locking mechanism includes a lock nut for locking the threaded shaft in place relative to a body, the lock nut including radially spaced tines that operatively interact with a body thereby locking the shaft in place once a desired separation has been achieved.

10. A cladding system for cladding a ferromagnetic surface, being an interior or exterior wall and/or ceiling section, or floor section, of an intermodal container, the cladding system including:
a plurality of adjustable magnetic couplers in accordance with claim 1; and
a plurality of ferromagnetic articles of cladding for removable operative attachment to the ferromagnetic surface of said container, a separation between said articles of cladding and the ferromagnetic surface adjustable by means of the adjustors of each magnetic coupler.

12-24. (canceled)

25. A method for cladding a ferromagnetic surface, being an interior or exterior wall and/or ceiling section, or floor section, of an intermodal container, said method including the steps of:
providing a plurality of adjustable magnetic couplers in accordance with claim 1;
providing a plurality of ferromagnetic articles of cladding; and
attaching and adjusting a separation between said articles of cladding and the ferromagnetic surface of said intermodal container by means of the adjustor of each magnetic coupler.
